(19) United States
(12) Patent Application Publication
(10) Pub. No.: US 2008/0283737 A1
(43) Pub. Date: Nov. 20, 2008

(54) BACKLIGHT MODULE AND CALIBRATION METHOD THEREOF

(75) Inventors: Te-Mei Wang, Hsinchu (TW); Yao-Jen Hsieh, Hsinchu (TW); Chih-Sung Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 11/842,175

(22) Filed: Aug. 21, 2007

(30) Foreign Application Priority Data
May 14, 2007 (TW) 96117009

(51) Int. Cl. G01J 1/42

(52) U.S. Cl. 250/252.1; 250/578.1

(57) ABSTRACT

A backlight module having a plurality of light emitting blocks is provided. The backlight module includes a plurality of light emitting devices and a plurality of photo-sensors. The light emitting devices are disposed in the light emitting blocks. Herein, the light emitting devices disposed in the same lighting block can be turned on simultaneously. Further, the photo-sensors are disposed among the light emitting blocks. Herein, the photo-sensors are capable of detecting the luminous intensity of the neighboring light emitting blocks. The photo-sensors of the above-mentioned backlight module can accurately detect the luminous intensity of each light emitting block. A calibration method of the backlight module is also provided.

### CROSS-REFERENCE TO RELATED APPLICATION

This application claims the priority benefit of Taiwan application serial no. 96117009, filed May 14, 2007. All disclosure of the Taiwan application is incorporated herein by reference.

### BACKGROUND OF THE INVENTION

1. Field of the Invention

The present invention relates to a light source module and a calibration method thereof. More particularly, the present invention relates to a backlight module having excellent luminance uniformity and a calibration method thereof.

2. Description of Related Art

A liquid crystal display (LCD) device is non-self-illuminating. Hence, it requires an external light source, such as a backlight module, to display images. The display quality of a liquid crystal display device is highly related to its accuracy in displaying colors. Further, the stability of the light source in the liquid crystal display is one of the key factors that determine whether the LCD device could accurately display colors. Because the high color purity of the light emitting diodes (LEDs), the light emitting diodes (LEDs) are gradually replacing the traditional backlight modules as the light emitting devices used in LCD devices. It should be noted that, in an LCD, as the time of use prolongs or the temperature of the backlight module changes, the optical properties of LEDs change as well. As a result, the color displayed by such a liquid crystal display device is altered.

Further, the backlight module detects such change in the optical properties of the light emitting devices mostly with the help of photo sensors in order to detect the optical properties of the light emitting devices according to the results detected by the photo sensors. Generally, one photo sensor can be disposed to correspond to one light emitting device in order to precisely correct the optical properties of each light emitting device. Nevertheless, using a large quantity of photo sensors will drastically increase the manufacturing costs thereof, especially when the size of the backlight module increases as the display panel gets larger. Consequently, some backlight modules are designed to include only one photo sensor in the center of the backlight module to cut down on the manufacturing costs. However, such design is not able to precisely calibrate and compensate the optical properties of each light emitting device.

### SUMMARY OF THE INVENTION

One aspect of the present invention is directed to a backlight module having photo sensors that can precisely detect the luminous intensity of each light emitting block without overly increasing the manufacturing costs.

Another aspect of the present invention is directed to a calibration method adapted for precisely calibrating the luminous intensity of each light emitting block.

Still another aspect of the present invention is directed to a backlight module having a plurality of light emitting blocks. The backlight module includes a plurality of light emitting devices and a plurality of photo sensors. Further, the light emitting devices are disposed in the light emitting blocks, and the light emitting devices disposed in the same light emitting block are lit simultaneously. In addition, the photo sensors are disposed in between light emitting blocks and each photo sensor is suitable for detecting the luminous intensity of the neighboring light emitting blocks.

In one embodiment of the present invention, each of the aforementioned light emitting blocks is a rectangular block, and the light emitting blocks are arranged in array.

In one embodiment of the present invention, every two aforementioned light emitting blocks that are adjacent to each other form a calibration block, and each photo sensor is respectively disposed in between two neighboring light emitting blocks. Under this design, if the number of photo sensors is P and the number of light emitting blocks is I, then P=I/2.

In one embodiment of the present invention, every four light emitting blocks that are adjacent to one another form a calibration block, and each photo sensor is respectively disposed in the center of each calibration block. Under this design, if the number of photo sensors is P and the number of light emitting blocks is I, then P=I/4.

In one embodiment of the present invention, each of the aforementioned light emitting blocks is a rectangular block, and the light emitting blocks are arranged in delta. In this embodiment, every three light emitting blocks that are adjacent to one another form a calibration block, and each photo sensor is respectively disposed in the center of each calibration block. Under this design, if the number of photo sensors is P and the number of light emitting blocks is I, then P=I/3.

In one embodiment of the present invention, the number of the aforementioned photo sensors is less than the number of the light emitting blocks.

In one embodiment of the present invention, the number of the aforementioned photo sensors is equal to the number of the light emitting blocks.

In one embodiment of the present invention, the aforementioned photo sensors are arranged orderly.

In one embodiment of the present invention, the photo sensors are evenly disposed among the light emitting blocks.

In one embodiment of the present invention, the light emitting device includes a plurality of light emitting diode (LED) packages. More specifically, the LED packages are, for example, white light LED packages.

Still another aspect of the present invention is directed to a calibration method adapted for correcting the backlight module described in the above-mentioned embodiments. This calibration method includes lighting a portion of the light emitting blocks that are adjacent to each photo sensor and measuring the luminous intensity of this portion of light emitting blocks using the photo sensor. Thereafter, another portion of the light emitting blocks that are adjacent to each photo sensor are lit and the luminous intensity of this portion of light emitting blocks is measured using each photo sensor.

In one embodiment of the present invention, when the light emitting blocks are arranged in delta, every three light emitting blocks adjacent to each other form a calibration block and each photo sensor is respectively disposed in the center of each calibration block, further comprising lighting the three light emitting blocks that are adjacent to each photo sensor sequentially.

In one embodiment of the present invention, when the light emitting blocks are arranged in array, every four light emitting blocks adjacent to each other form a calibration blocks and each photo sensor is respectively disposed in the center of each calibration block, further comprising lighting the four light emitting blocks that are adjacent to each photo sensor sequentially.

In one embodiment of the present invention, the aforementioned calibration method further includes simultaneously lighting the light emitting blocks that are adjacent to each photo sensor.

In the backlight module of the present invention, the plurality of light emitting devices in each light emitting block are lit simultaneously, and each photo sensor is disposed corresponding to a plurality of light emitting blocks. Simultaneously, each photo sensor can detect light emitted from a different light emitting block that is adjacent to the one the photo sensor is disposed in. Therefore, in the backlight module of the present invention, the number of the photo sensors used is efficiently decreased such that the manufacturing costs are cut down. On the other hand, the photo sensor can also accurately detect the light emitted from each light emitting block to further improve the luminance uniformity of the backlight module.

In order to make the above and other objects, features and advantages of the present invention more comprehensible, several embodiments accompanied with figures are described in detail below.

### BRIEF DESCRIPTION OF THE DRAWINGS

FIG. 1 is a schematic view illustrating a backlight module according to the first embodiment of the present invention.

FIG. 2 schematically illustrates the luminous intensity distribution of the rectangular light emitting block 110 when it is lit.

FIG. 3 is a schematic view illustrating a backlight module according to the second embodiment of the present invention.

FIG. 4 is a schematic view illustrating a calibration method according to one embodiment of the present invention.

FIG. 5A through FIG. 5D are schematic views illustrating the method of correcting the backlight module 100.

### DESCRIPTION OF EMBODIMENTS

### First Embodiment

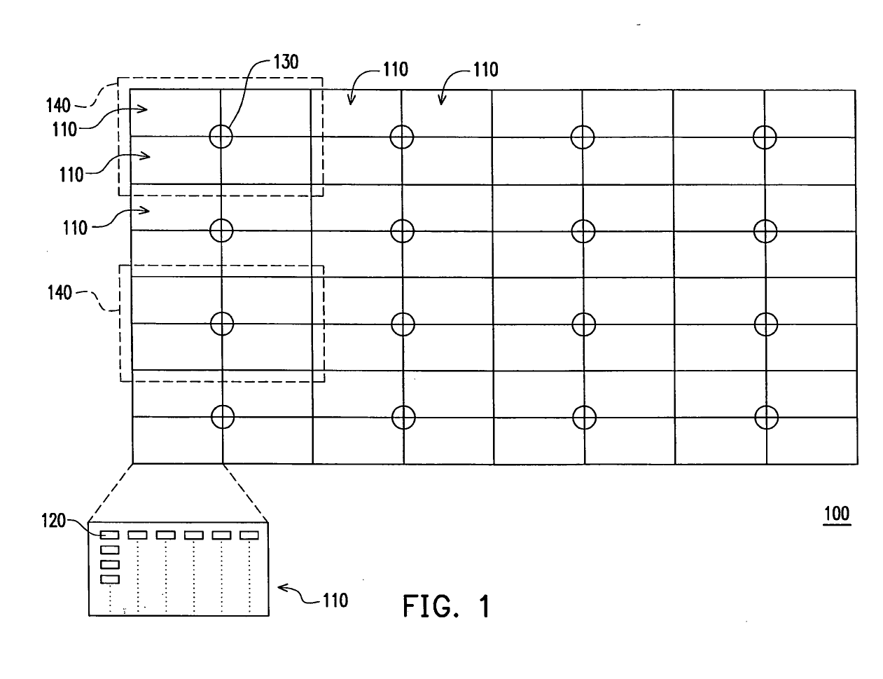

FIG. 1 is a schematic view illustrating a backlight module according to the first embodiment of the present invention. Referring to FIG. 1, in the present embodiment, a backlight module 100 having a plurality of light emitting blocks 110 includes a plurality of light emitting devices and a plurality of photo sensors 130. Further, the light emitting devices 120 are disposed in the light emitting blocks 110, and the light emitting devices 120 disposed in the same light emitting block 110 are lit simultaneously. In addition, the photo sensors 130 are disposed in between light emitting blocks 110, and each photo sensor 130 is suitable for detecting the luminous intensity of the light emitting blocks 110 neighboring to the photo sensors 130. According to FIG. 1, each photo sensor 130 can detect the luminous intensity of one or more light emitting blocks that it is adjacent to, or simultaneously detect the luminous intensity of all of the light emitting blocks 110 that it is adjacent to.

For example, in the backlight module 100 of the present embodiment, the light emitting devices 120 are light emitting diode (LED) packages. Herein, the LED packages may be different types of packages such as surface mount technology (SMD) type packages and pin through hole (PTH) type packages. In the present embodiment, the light emitting device 120 is, for example, a white light LED package that includes a single LED chip and fluorescent materials suitable for emitting short-wavelength light, or a plurality of LED chips emitting monochromatic light. In the present embodiment, a plurality of light emitting devices 120 is disposed in each light emitting block 110. It is noted that the number and the construct of light emitting devices 120 disposed can be varied according to the actual requirements. The plurality of the light emitting devices 120 disposed in the same light emitting block 110 can be controlled by one control circuit. For example, when the control circuit outputs a driving current to the light emitting devices 120 in a light emitting block 110, all the light emitting devices 120 in the light emitting block 110 are turned on. As shown in FIG. 1, each light emitting block 110 may be a rectangular block, and the light emitting blocks 110 are arranged in array.

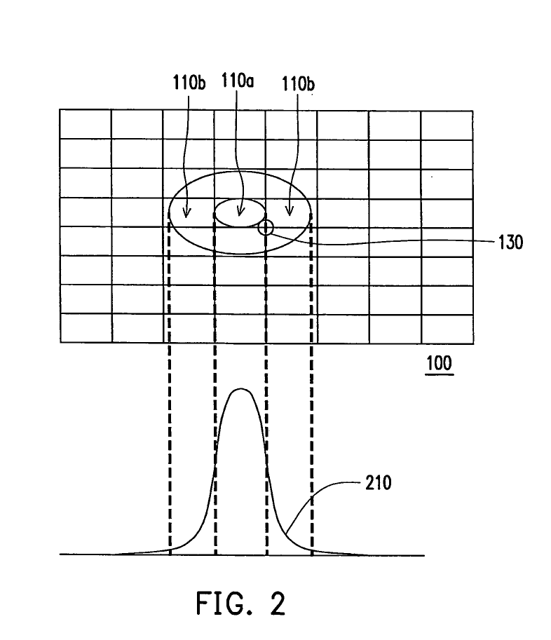

FIG. 2 schematically illustrates the luminous intensity distribution of the rectangular light emitting block 110a when it is lit. Referring to FIG. 2, when the light emitting block 110a is lit, there is shown by curve 210 a luminous intensity distribution. In regions other than the light emitting block 110a, the luminous intensity of the light emitting block 110a is greatly reduced. Further, in regions other than the light emitting blocks 110b adjacent to the light emitting block 110a, the luminous intensity of the light emitting block 110a can barely be detected.

In the present embodiment, light emitting blocks 110 are arranged in rectangle as shown in FIG. 1. To efficiently calibrate the luminous intensity of the light emitting blocks 110, every four (i.e. 2×2) light emitting blocks 110 that are adjacent to one another are defined as one calibration block 140. Further, each photo sensor 130 is disposed in the center of each calibration block 140. Under this design, if the number of photo sensors 130 is P and the number of light emitting blocks 110 is I, then P=I/4.

In FIG. 1, the backlight module 100 is formed by 8×8 rectangular light emitting blocks 110 arranged in array. Hence, in the present embodiment, the number of the light emitting blocks 110 is 64 and the number of the photo sensors 130 is thus 16. In other words, when H light emitting devices 120 are disposed in each light emitting block 110, one photo sensor 130 can be used to calibrate the luminous intensity of the surrounding 4H light emitting devices 120. In other words, the number of the photo sensors 130 required is less than the number of the light emitting devices 120. Therefore, the manufacturing costs of the photo sensors 130 required is reduced. In addition, the photo sensors 130 shown in FIG. 1 are arranged orderly. More specifically, orderly arrangement means that the photo sensors are evenly disposed among each block.

Nevertheless, the present invention does not exclude other ways of arranging the photo sensors 130. For example, to cut down on the manufacturing costs required for the photo sensors 130, every 16 (i.e. 4×4) adjacent light emitting blocks 110 can be grouped to form a calibration block 140 and one photo sensor 130 is disposed in the center of every calibration block 140. Further, when no photo sensor 130 is disposed in the center of the backlight module 100, a photo sensor 130 can be disposed in the center of the backlight module 100. Under this design, the number of the photo sensors 130 is still less than the number of the light emitting blocks 110. However, in other embodiments, one photo sensor 130 may be disposed to correspond to two adjacent light emitting blocks 110 to improve the accuracy in detecting light. Or, one photo sensor 130 is disposed to correspond to one light emitting block 110. Under this design, the number of the photo sensors 130 is equal to the number of the light emitting blocks 110.

### Second Embodiment

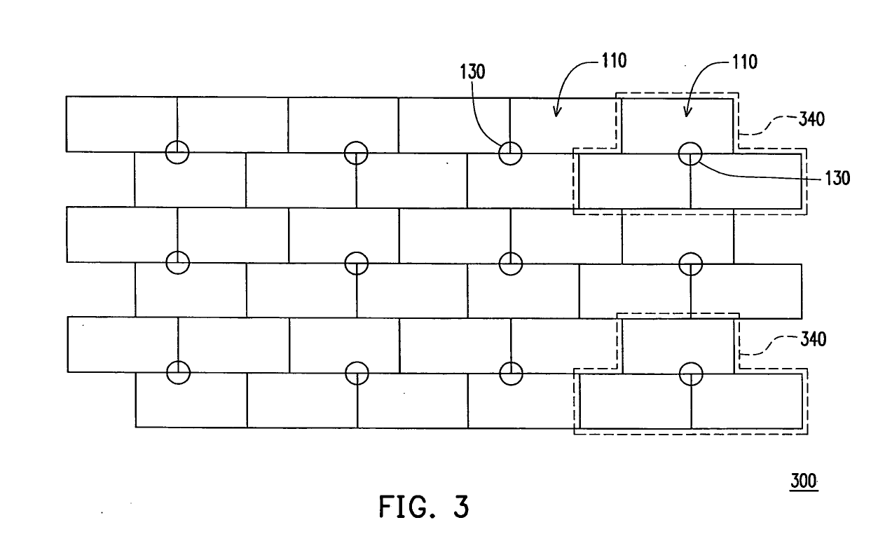

FIG. 3 is a schematic view illustrating a backlight module according to the second embodiment of the present invention. Referring to FIG. 3, the elements in a backlight module 300 are identical to the elements in the backlight module 100. Hence, a detailed description thereof is omitted. However, it should be noted that the major difference between the backlight module 300 and the backlight module 100 is that light emitting blocks 110 in the backlight module 300 are arranged in delta. In this embodiment, every three light emitting blocks 110 that are adjacent to one another form a calibration block 340, and each photo sensor 130 is respectively disposed in the center of the calibration block 340. Under this design, if the number of photo sensors 130 is P and the number of light emitting blocks 110 is I, then P=I/3. Certainly, those skilled in the art of the present invention would appreciate that the constructs of the photo sensors 130 and the calibration blocks 340 may be modified according to the actual requirements. Hence, the present invention is not limited thereto. For example, the division of a calibration block 340 may be enlarged or shrunk in order to reach an optimal balance between the manufacturing cost and the product quality.

The present invention is directed to another calibration method adapted for correcting the backlight module described in the above-mentioned embodiments.

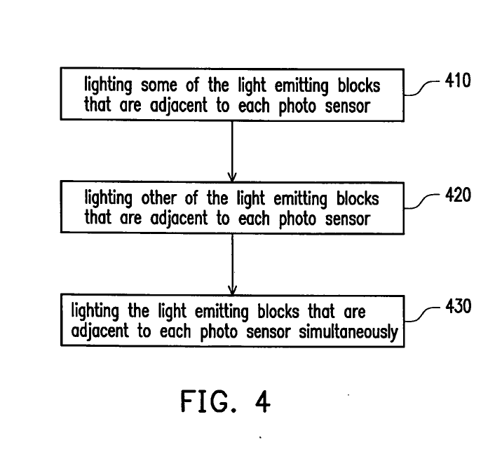

FIG. 4 is a schematic view illustrating a calibration method according to one embodiment of the present invention. Referring to FIG. 4, the calibration method, for example, includes the following steps. First, some of the light emitting blocks that are adjacent to each photo sensor are first lit and the luminous intensity of these light emitting blocks that are lit are calibrated by the photo sensor in order to perform correction or compensation to the luminous intensity of the light emitting blocks (step 410). Thereafter, other of light emitting blocks that are adjacent to each photo sensor are lit and the luminous intensity of the light emitting blocks are measured using the photo sensor (step 420). As a result, the luminous intensity of the light emitting blocks that are adjacent to each photo sensor are measured successively and then calibrated.

According to another embodiment of the present invention, the calibration method includes lighting the light emitting blocks that are adjacent to each photo sensor simultaneously for performing light-on test and calibration (step 430). Step 430 may be performed prior to step 410 or after step 420. Certainly, step 430 may be performed after step 410 but prior to step 420.

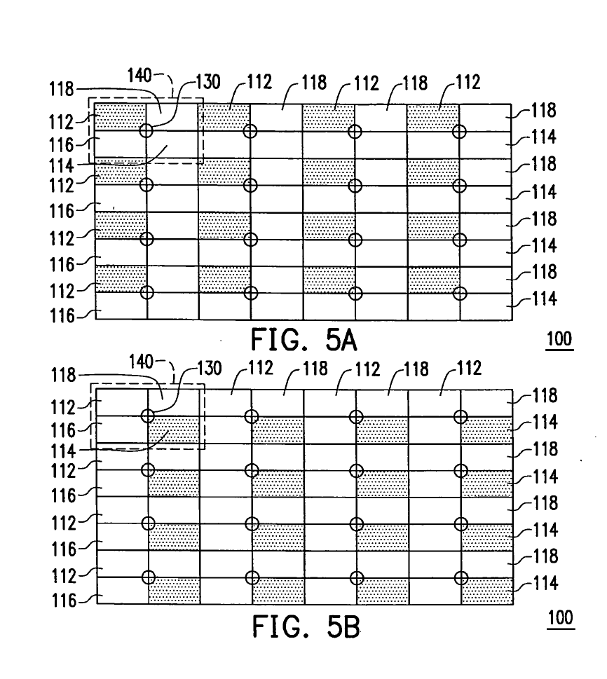

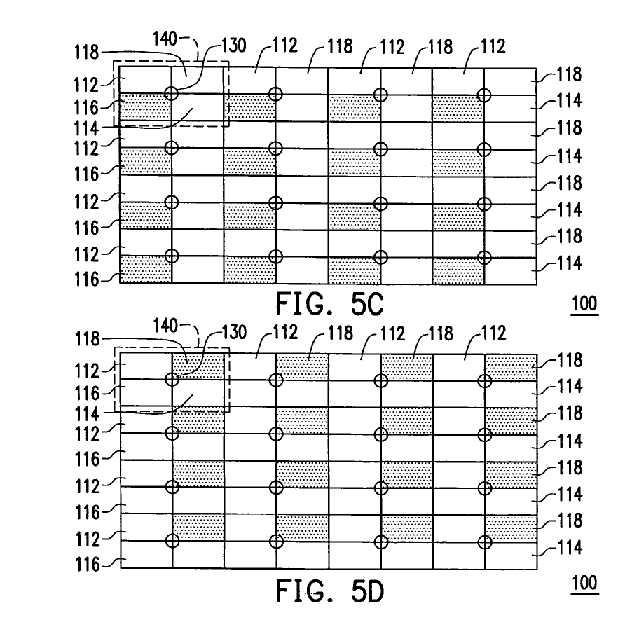

FIG. 5A through FIG. 5D are schematic views illustrating the steps for correcting the backlight module 100. Referring to FIG. 5A, in a backlight module 100, every four light emitting blocks that are adjacent to one photo sensor 130 may be defined as a first light emitting block 112, a second light emitting block 114, a third light emitting block 116, and a fourth light emitting block 118. If all the light emitting blocks 112, 114, 116 and 118 in the backlight module 100 are to be calibrated, the first light emitting blocks 112 that are adjacent to each photo sensor 130 may be lit first for each photo sensor 130 to perform calibration of luminous intensity to the first light emitting blocks 112. Simultaneously, the results measured by each photo sensor 130 may be fed back to the control circuit in order to perform calibration to the luminous intensity of the first light emitting blocks 112. According to an embodiment of the present invention, photo sensors 130 are arranged orderly, that is the photo sensors 130 are evenly disposed among each light emitting block to ensure the efficiency for correcting the luminous intensity is consistent throughout every block.

Next, as shown in FIG. 5B through FIG. 5D, the second light emitting block 114, the third light emitting block 116, and the fourth light emitting block 118 that are adjacent to each photo sensor 130 are lit in sequence and the luminous intensity of each block is calibrated. Similarly, the result measured by each photo sensor 130 may be fed back to the control circuit and the luminous intensity of each block is corrected.

In another embodiment, the light emitting blocks may be arranged in delta as the backlight module 300 shown in FIG. 3. In this embodiment, every three light emitting blocks 110 that are adjacent to one another form a calibration block 340, and each photo sensor 130 is respectively disposed in the center of the calibration block 340. Simultaneously, the calibration method of the backlight module 300 includes sequentially lighting the three light emitting blocks that are adjacent to each photo sensor 130. As a result, each photo sensor 130 may sequentially measure the luminous intensity of the three light emitting blocks 110 that are adjacent to the photo sensor 130.

Certainly, all the other light emitting blocks 110 that are adjacent to each photo sensor 130 may be simultaneously lit up before, after or during the process of lighting up the plurality of light emitting blocks 110 that are adjacent to each photo sensor 130 sequentially.

Accordingly, the backlight module and the calibration method of the present invention have at least the following advantages. First, in the backlight module of the present invention, the location where the photo sensor is disposed is in the center of the adjacent light emitting blocks such that the photo sensor can accurately detect the luminous intensity of each light emitting block. Hence, the calibration method of the present invention can accurately correct the luminous intensity of the backlight module. Further, in the backlight module of the present invention, a photo sensor may be disposed to correspond to a plurality of light emitting devices consisting of light emitting diode packages. Therefore, no plurality of photo sensors is required, which helps lower the manufacturing costs of the backlight module. On the whole, the present invention ensures excellent light emitting effect of the backlight module without increasing the manufacturing costs thereof.

It will be apparent to those skilled in the art that various modifications and variations can be made to the structure of the present invention without departing from the scope or spirit of the invention. In view of the foregoing, it is intended that the present invention cover modifications and variations of this invention, provided they fall within the scope of the following claims.

What is claimed is:

1. A backlight module having a plurality of light emitting blocks, comprising:
a plurality of light emitting devices disposed in the light emitting blocks, wherein the light emitting devices disposed in one light emitting block are lit simultaneously; and
a plurality of photo sensors disposed in between the light emitting blocks, wherein each photo sensor is adapted for detecting the luminous intensity of the adjacent light emitting blocks.

2. The backlight module of claim 1, wherein each light emitting block comprises a rectangular block, and the light emitting blocks are arranged in array.

3. The backlight module of claim 2, wherein every two light emitting blocks that are adjacent to each other form a calibration block, and each photo sensor is respectively disposed in between two adjacent light emitting blocks.

4. The backlight module of claim 3, wherein the number of the photo sensors is P and the number of the light emitting blocks is I, and P=I/2.

5. The backlight module of claim 2, wherein every four light emitting blocks that are adjacent to one another form a calibration block, and each photo sensor is respectively disposed in the center of each calibration block.

6. The backlight module of claim 5, wherein the number of the photo sensors is P and the number of the light emitting blocks is I, and P=I/4.

7. The backlight module of claim 1, wherein each light emitting block comprises a rectangular block, and the light emitting blocks are arranged in delta.

8. The backlight module of claim 7, wherein every three light emitting blocks that are adjacent to one another form a calibration block, and each photo sensor is respectively disposed in the center of each calibration block.

9. The backlight module of claim 8, wherein the number of the photo sensors is P and the number of the light emitting blocks is I, and P=I/3.

10. The backlight module of claim 1, wherein the number of the photo, sensors is equal to or less than the number of the light emitting blocks.

11. The backlight module of claim 1, wherein the photo sensors are arranged orderly.

12. The backlight module of claim 11 wherein the photo sensors are evenly distributed among the light emitting blocks.

13. The back light module of claim 1, wherein the light emitting devices comprises a plurality of light emitting diode (LED) packages.

14. The backlight module of claim 13, wherein at least one of the LED packages comprises a white light LED package.

15. A calibration method for correcting the backlight module of claim 1, comprising:
lighting some of the light emitting blocks that are adjacent to each photo sensor and measuring the luminous intensity of these light emitting blocks using the photo sensor; and
lighting other light emitting blocks that are adjacent to each photo sensor and measuring the luminous intensity of this portion of the light emitting blocks using the photo sensor.

16. The calibration method of claim 15, further comprising lighting three light emitting blocks that are adjacent to each photo sensor sequentially, wherein the light emitting blocks are arranged in delta, every three light emitting blocks adjacent to each other form a calibration block, and each photo sensor is respectively disposed in the center of each calibration block.

17. The calibration method of claim 15, further comprising lighting four light emitting blocks that are adjacent to each photo sensor sequentially, wherein the light emitting blocks are arranged in array, every four light emitting blocks adjacent to each other form a calibration blocks, and each photo sensor is respectively disposed in the center of each calibration block.

18. The calibration method of claim 15, further comprising simultaneously lighting the light emitting blocks that are adjacent to each photo sensor.
